(19) United States
(12) Patent Application Publication
(10) Pub. No.: US 2025/0298258 A1
(43) Pub. Date: Sep. 25, 2025

(54) OPTICAL SENSING DEVICE

(71) Applicant: GUANGZHOU LUXVISIONS INNOVATION TECHNOLOGY LIMITED, Guangzhou City (CN)

(72) Inventors: Tzu-Yao Lin, Guangzhou City (CN); Shih-Chieh Yen, Guangzhou City (CN)

(73) Assignee: GUANGZHOU LUXVISIONS INNOVATION TECHNOLOGY LIMITED, Guangzhou City (CN)

(21) Appl. No.: 19/008,593

(22) Filed: Jan. 2, 2025

Related U.S. Application Data
(60) Provisional application No. 63/567,432, filed on Mar. 20, 2024.

(30) Foreign Application Priority Data
Aug. 23, 2024 (CN) 202411167198.2

(51) Int. Cl. G02B 27/09

(52) U.S. Cl. CPC G02B 27/0944; G02B 27/0955; G02B 27/0994

(57) ABSTRACT

An optical sensing device including a waveguide, a first holographic diffraction grating, a second holographic diffraction grating, a lens element, and a sensing element is provided. The first holographic diffraction grating is attached to a first surface of the waveguide. The second holographic diffraction grating is attached to a second surface of the waveguide. The lens element is disposed between the waveguide and the sensing element by corresponding to the second holographic diffraction grating. A grating refractive index of the first holographic diffraction grating and the second holographic diffraction grating is between 1.5 and 1.8, a value of refractive index modulation is between 0.03 and 0.045, a thickness is between 10 μm and 20 μm, a spatial period is between 300 nm and 500 nm, and a grating slant angle is between 20 degrees and 30 degrees.

### CROSS-REFERENCE TO RELATED APPLICATION

This application claims the priority benefit of U.S. Provisional Patent Application Ser. No. 63/567,432, filed Mar. 20, 2024, and China application serial no. 202411167198.2, filed on Aug. 23, 2024. The entirety of the above-mentioned patent applications is hereby incorporated by reference herein and made a part of this specification.

### BACKGROUND

### Technical Field

The invention relates to an optical sensing device.

### Description of Related Art

Optical sensing devices such as 3D ranging devices, imaging devices, or mid-infrared gas detection devices, etc., usually utilize prisms or reflectors to control a propagating direction of light, which leads to excessively large sizes of these optical sensing devices, so that the optical sensing devices cannot be accommodated in a small space.

### SUMMARY

The invention is directed to an optical sensing device, which does not require a prism or a reflector and is adapted to be arranged in a small space.

An embodiment of the invention provides an optical sensing device including a waveguide, a first holographic diffraction grating, a second holographic diffraction grating, a lens element, and a sensing element. The first holographic diffraction grating is attached to a first surface of the waveguide. The second holographic diffraction grating is attached to a second surface of the waveguide. The lens element is disposed between the waveguide and the sensing element by corresponding to the second holographic diffraction grating. A grating refractive index of the first holographic diffraction grating and the second holographic diffraction grating is between 1.5 and 1.8, a value of refractive index modulation is between 0.03 and 0.045, a thickness is between 10 μm and 20 μm, a spatial period is between 300 nm and 500 nm, and a grating slant angle is between 20 degrees and 30 degrees.

An embodiment of the invention provides an optical sensing device including a waveguide, a first holographic diffraction grating, a second holographic diffraction grating, a lens element, and a sensing element. The first holographic diffraction grating is attached to a first surface of the waveguide. The second holographic diffraction grating is attached to a second surface of the waveguide. The lens element is disposed between the waveguide and the sensing element by corresponding to the second holographic diffraction grating. A grating refractive index of the first holographic diffraction grating and the second holographic diffraction grating is between 1.5 and 1.8, a value of refractive index modulation is between 0.01 and 0.03, a thickness is between 1 μm and 5 μm, a spatial period is between 300 nm and 500 nm, and a grating slant angle is between 20 degrees and 30 degrees.

According to the above descriptions, the optical sensing device provided by the embodiment of the invention utilizes the first holographic diffraction grating and the second holographic diffraction grating to change a propagating direction of light, where the first holographic diffraction grating and the second holographic diffraction grating have high diffraction efficiency and thin thickness. Therefore, the optical sensing device may be secretly disposed in a small space such as a protective cover of a mobile phone or a laptop computer, which achieves good security and privacy.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an optical sensing device according to an embodiment of the invention.

FIG. 2 is a schematic diagram of a holographic diffraction grating according to an embodiment of the invention.

FIG. 3 is a schematic diagram of an optical sensing device according to an embodiment of the present invention.

### DESCRIPTION OF THE EMBODIMENTS

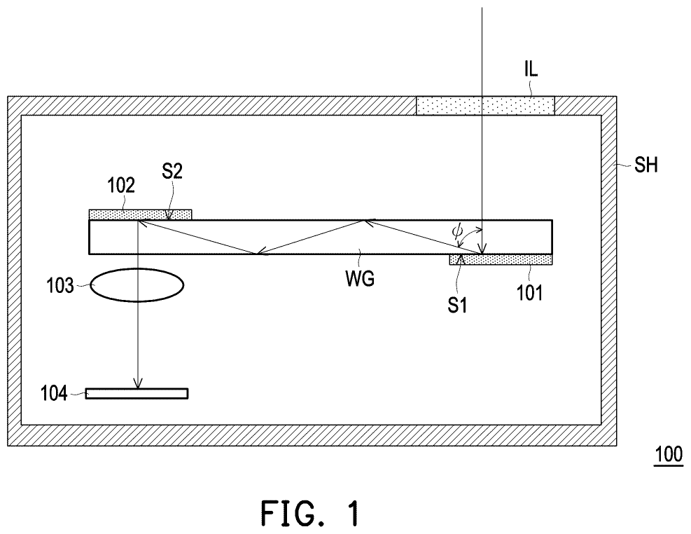

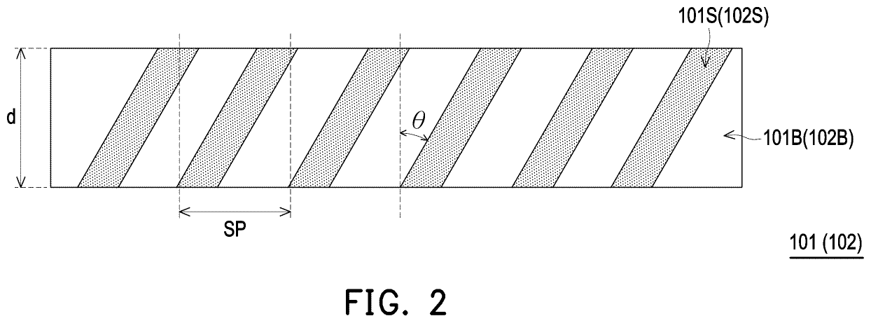

Referring to FIG. 1 and FIG. 2, an optical sensing device 100 according to an embodiment of the invention includes a shell SH, a waveguide WG, a first holographic diffraction grating 101, a second holographic diffraction grating 102, a lens element 103, and a sensing element 104. The first holographic diffraction grating 101 is attached to a first surface S1 of the waveguide WG. The second holographic diffraction grating 102 is attached to a second surface S2 of the waveguide WG. The lens element 103 is disposed between the waveguide WG and the sensing element 104, and is corresponding to the second holographic diffraction grating 102. A refractive index of the waveguide WG is between 1.5 and 1.8.

A grating refractive index of the first holographic diffraction grating 101 and a grating refractive index of the second holographic diffraction grating 102 are between 1.5 and 1.8. The value of refractive index modulation of the first holographic diffraction grating 101 and the value of refractive index modulation of the second holographic diffraction grating 102 are between 0.03 and 0.045. That is, a refractive index of a grating structure 101S of the first holographic diffraction grating 101 is 0.03 to 0.045 higher than the refractive index of the substrate 101B, and a refractive index of a grating structure 102S of the second holographic diffraction grating 102 is 0.03 to 0.045 higher than the refractive index of the substrate 102B. A thickness d of the first holographic diffraction grating 101 and the second holographic diffraction grating 102 is between 10 μm and 20 μm, and a spatial period SP of the grating structure 101S and the grating structure 102S is between 300 nm and 500 nm. Namely, the grating structure 101S and the grating structure 102S are structures that are repeated while taking a length ranging from 300 nm to 500 nm as a period. A grating slant angle θ (i.e., the angle θ between the grating structure 101S and a normal line of the surface of the first holographic diffraction grating 101 and the angle θ between the grating structure 102S and a normal line of the surface of the second holographic diffraction grating 102) is between 20 degrees and 30 degrees. According to the above-mentioned configuration, a diffraction efficiency of the first holographic diffraction grating 101 and the second holographic diffraction grating 102 of the embodiment for light with a wavelength of 940 nm may be greater than or equal to 90%.

The shell SH includes a light incident portion IL corresponding to the first holographic diffraction grating 101, a transmittance of the light incident portion IL is between 50% and 80%, or between 50% and 70%, and a transmittance of other parts of the shell SH except the light incident portion IL for the light with a wavelength of 940 nm is less than 10%. In some embodiments, the shell SH is a protective cover of a mobile phone or a laptop computer, and the waveguide WG, the first holographic diffraction grating 101, the second holographic diffraction grating 102, the lens element 103 and the sensing element 104 of the optical sensing device 100 are hidden in the shell SH, which has security and privacy. It should be noted that, since the diffraction efficiency of the first holographic diffraction grating 101 and the second holographic diffraction grating 102 of the embodiment for the light with a wavelength of 940 is greater than or equal to 90%, even if the transmittance of the light incident portion IL is less than or equal to 80%, the optical sensing device 100 may still have good sensing accuracy.

It should also be noted that, compared to an optical sensing device using a prism or a reflector, the optical sensing device 100 of the embodiment utilizes the first holographic diffraction grating 101 and the second holographic diffraction grating 102 with a thin thickness to change a propagating direction of light, so that the optical sensing device 100 may be accommodated in a small space, such as in a protective cover of a mobile phone or a laptop computer.

Furthermore, the optical sensing device 100 of the embodiment utilizes the first holographic diffraction grating 101 and the second holographic diffraction grating 102 to change a propagating direction of light, and for the light with a wavelength of 940 nm, diffraction angles φ of the first holographic diffraction grating 101 and the second holographic diffraction grating 102 are between 50 degrees and 60 degrees, which satisfies a total reflection condition of the waveguide WG with a refractive index between 1.5 and 1.8, and may greatly reduce optical energy loss in the process of light propagating from the first holographic diffraction grating 101 to the second holographic diffraction grating 102.

In an embodiment, an F number of the lens element 103 is, for example, 2.1, an effective focal length (EFL) is 21 mm, and an aperture is 10 mm. The optical effective diameter of a surface of the lens element 103 facing the waveguide WG is 0.061 mm, an optical effective diameter of a surface of the lens element 103 facing away from the waveguide WG is 0.037 mm, a thickness of the lens element 103 is 9.33 mm, and a refractive index of the lens element 103 is 1.5, but the invention is not limited thereto.

In an embodiment, the waveguide WG has a thickness of 1 mm, a length within a range of 30 mm to 70 mm, and a width within a range of 30 mm to 50 mm, and the waveguide WG may include, for example, SiO₂, Al₂O₃, or SiC, but the invention is not limited thereto.

In order to fully illustrate various embodiments of the invention, other embodiments of the invention will be described below. It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

Referring to FIG. 1 and FIG. 2, in an optical sensing device 100 according to another embodiment of the invention, the refractive index of the waveguide WG is between 1.5 and 1.8, the grating refractive index of the first holographic diffraction grating 101 and the grating refractive index of the second holographic diffraction grating 102 are between 1.5 and 1.8. The values of refractive index modulation of the first holographic diffraction grating 101 and the second holographic diffraction grating 102 is between 0.01 and 0.03, and the thickness d is between 1 μm and 5 μm. The spatial period SP of the grating structure 101S and the grating structure 102S is between 300 nm and 500 nm, and the grating slant angle θ is between 20 degrees and 30 degrees. The optical sensing device 100 provided according to the embodiment may have a larger field of view (FOV). That is, a viewing angle of a range sensed by the optical sensing device 100 of the embodiment is larger.

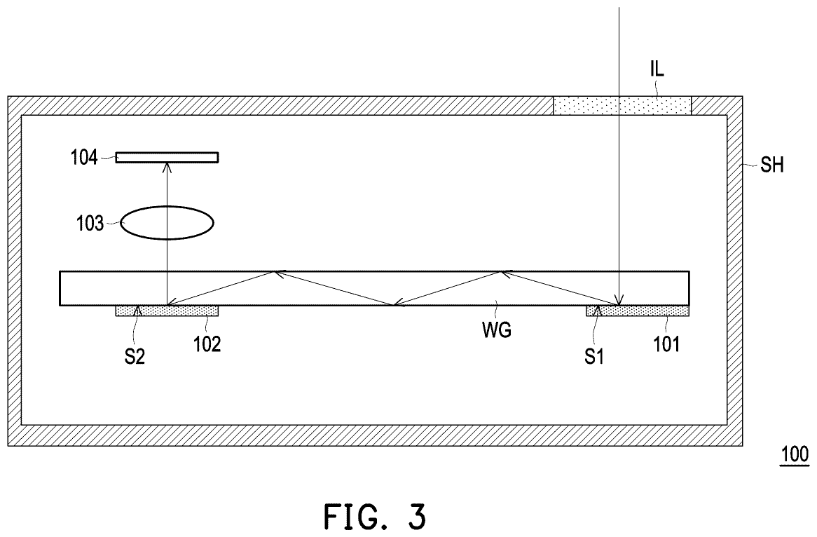

In the above-mentioned embodiment, the first surface S1 and the second surface S2 are located on different sides of the waveguide WG, and the lens element 103 and the sensing element 104 are located on the same side of the waveguide WG as the first surface S1. However, the invention is not limited thereto, and in some embodiments, referring to FIG. 3, the first surface S1 and the second surface S2 of the optical sensing device 100 may be located on the same side of the waveguide WG, and the lens element 103 and the sensing element 104 are located on a different side of the waveguide WG from the first surface S1.

In summary, the optical sensing device provided by the embodiment of the invention utilizes the first holographic diffraction grating and the second holographic diffraction grating to change a propagating direction of light, where the first holographic diffraction grating and the second holographic diffraction grating have high diffraction efficiency and thin thickness. Therefore, the optical sensing device may be secretly disposed in a small space such as a protective cover of a mobile phone or a laptop computer, which achieves good security and privacy.

What is claimed is:

1. An optical sensing device, comprising:
a waveguide;
a first holographic diffraction grating, attached to a first surface of the waveguide;
a second holographic diffraction grating, attached to a second surface of the waveguide;
a lens element; and
a sensing element, wherein the lens element is disposed between the waveguide and the sensing element and corresponding to the second holographic diffraction grating,
wherein a grating refractive index of the first holographic diffraction grating and the second holographic diffraction grating is between 1.5 and 1.8, the first holographic diffraction grating and the second holographic diffraction grating have a value of refractive index modulation between 0.03 and 0.045, a thickness between 10 μm and 20 μm, a spatial period between 300 nm and 500 nm, and a grating slant angle between 20 degrees and 30 degrees.

2. The optical sensing device as claimed in claim 1, further comprising a shell, and the shell comprising a light incident portion corresponding to the first holographic diffraction grating, and a transmittance of the light incident portion being between 50% and 80%.

3. The optical sensing device as claimed in claim 2, wherein the transmittance of the light incident portion is between 50% and 70%.

4. The optical sensing device as claimed in claim 1, wherein the first surface and the second surface are located on a same side of the waveguide.

5. The optical sensing device as claimed in claim 1, wherein the first surface and the second surface are located on different sides of the waveguide.

6. The optical sensing device as claimed in claim 1, wherein a refractive index of the waveguide is the same as the grating refractive index.

7. The optical sensing device as claimed in claim 6, wherein for light with a wavelength of 940 nm, a diffraction angle of the first holographic diffraction grating and the second holographic diffraction grating is between 50 degrees and 60 degrees.

8. The optical sensing device as claimed in claim 1, wherein for light with a wavelength of 940 nm, a diffraction efficiency of the first holographic diffraction grating and the second holographic diffraction grating is greater than or equal to 90%.

9. An optical sensing device, comprising:
a waveguide;
a first holographic diffraction grating, attached to a first surface of the waveguide;
a second holographic diffraction grating, attached to a second surface of the waveguide;
a lens element; and
a sensing element, wherein the lens element is disposed between the waveguide and the sensing element and corresponding to the second holographic diffraction grating,
wherein a grating refractive index of the first holographic diffraction grating and the second holographic diffraction grating is between 1.5 and 1.8, the first holographic diffraction grating and the second holographic diffraction grating have a value of refractive index modulation between 0.01 and 0.03, a thickness between 1 μm and 5 μm, a spatial period between 300 nm and 500 nm, and a grating slant angle between 20 degrees and 30 degrees.

10. The optical sensing device as claimed in claim 9, wherein a refractive index of the waveguide is the same as the grating refractive index.
